(19) United States
(12) Patent Application Publication
(10) Pub. No.: US 2025/0174145 A1
(43) Pub. Date: May 29, 2025

(54) SYSTEMS AND METHODS FOR DEVELOPMENT OF TRAINING PROGRAMS FOR PEOPLE BASED ON TRAINING DATA AND OPERATION DATA

(71) Applicant: THE BOEING COMPANY, Arlington, VA (US)

(72) Inventor: Sasha Lightbourne, Ft. Lauderdale, FL (US)

(21) Appl. No.: 18/522,499

(22) Filed: Nov. 29, 2023

(51) Int. Cl. G09B 9/08

(52) U.S. Cl. CPC G09B 9/08

(57) ABSTRACT

A system includes a data lake including data associated with training and operation of particular equipment. The system also includes one or more processors configured to execute instructions to use a training skill model to determine training skill scores for a member of an entity associated with use of the particular equipment, to use an operation skill model to determine operation skill scores for use of the particular equipment by the member, to use an anomalous state probability model to determine anomalous state profiles associated with the particular equipment for the member, and to use a decision engine to determine a training program for the member based on the anomalous state profiles.

### FIELD OF THE DISCLOSURE

The subject disclosure is generally related to systems and methods for development of training programs for people based on training data and operation data.

### BACKGROUND

Training programs teach people how to appropriately use particular systems. The particular systems include applications in transportation (e.g., land based transport using vehicles, air transport, and water based transport), agriculture, construction, defense, insurance, healthcare, manufacturing, mining, and other industrial and non-industrial environments. A system may include particular equipment (e.g., a car, an aircraft, medical equipment, manufacturing equipment, etc.), software, interfaces, or combinations thereof. Training programs are designed to have particular desired results. The desired results can include improvements in proficiency, efficiency, safety, and customer satisfaction.

Many training programs for particular systems are developed for new equipment, equipment improvements, and in response to incidents associated with equipment in use. Many training programs remain unchanged even though there are progressive changes in design, automation, system integration, and reliability associated with the particular system that result in such training programs being out of date. For many systems, data related to training and operational environments is gathered for people associated with the systems. For example, data associated with particular training programs taken by aircraft pilots and data associated with each flight piloted by an aircraft pilot is gathered. There is a need to be able to develop training programs for people with up to date content, with content based on analysis of training and operational environments, and based on currently available equipment.

### SUMMARY

In a particular implementation, a method includes receiving, at one or more computing systems of a training development system, a request to determine training programs for members of an entity from a requestor. The method includes determining, at the one or more computing systems, training skill scores for a member of the entity for monitored conditions based on a training history associated with the member. The method includes determining, at the one or more computing systems, operation skill scores for the member for the monitored conditions based on operation history associated with the member. The method includes determining, at the one or more computing systems, a first anomalous state probability profile for the member based on the training skill scores and the operation skill scores. The method includes determining, at the one or more computing systems, additional anomalous state probability profiles for the member based on the member having additional training from sets of one or more training courses. The method also includes generating, at the one or more computing systems, a training program for the member based on the first anomalous state probability profile and the additional anomalous state probability profiles. The training program specifies one or more training courses for the member.

In another particular implementation, a non-transitory, computer-readable medium includes instructions that, when executed by one or more processors, cause the one or more processors to receive a request to determine a training program for a member of an entity from a requestor. The instructions cause the one or more processors to determine training skill scores for the member for monitored conditions based on a training history associated with the member. The instructions cause the one or more processors to determine operation skill scores for the member for the monitored conditions based on operation history associated with the member. The instructions cause the one or more processors to determine a first anomalous state probability profile for the member based on the training skill scores and the operation skill scores. The instructions cause the one or more processors to determine additional anomalous state probability profiles for the member based on the member having additional training from sets of one or more training courses. The instructions also cause the one or more processors to generate a training program for the member based on the first anomalous state probability profile and the additional anomalous state probability profiles. The training program specifies one or more training courses for the member.

In another particular implementation, a system includes a data lake including data associated with training and operation of particular equipment. The system also includes one or more processors configured to execute instructions to use a training skill model to determine training skill scores for a member of an entity associated with use of the particular equipment, to use an operation skill model to determine operation skill scores for use of the particular equipment by the member, to use an anomalous state probability model to determine anomalous state profiles associated with the particular equipment for the member, and to use a decision engine to determine a training program for the member based on the anomalous state profiles.

The features, functions, and advantages described herein can be achieved independently in various implementations or can be combined in yet other implementations, further details of which can be found with reference to the following description and drawings.

### BRIEF DESCRIPTION OF THE DRAWINGS

FIG. 1 depicts a block diagram of a system for developing training programs for aircraft pilots based on training skill scores and operation skill scores.

FIG. 2 depicts a flow chart of an implementation of a method of generating training programs.

FIG. 3 depicts a flow chart of an implementation of a method for generating information associated with updating one or more existing training courses, material for one or more new courses, or both.

FIG. 4 is a block diagram of a computing environment including a computing device configured to support aspects of computer-implemented methods and computer-executable program instructions (or code) according to the present disclosure

### DETAILED DESCRIPTION

The disclosure is directed to improving training of people who use systems and includes development of training programs and groups of training programs for people working in particular environments. The people use particular equipment. Specific examples provided herein are directed to applications in aviation for the use of aircraft by aircraft pilots for convenience, but the concepts are applicable to applications in other environments.

Training programs for aircraft pilots seek to enhance pilot knowledge, skills, and abilities to enable efficient and effective operation of equipment (e.g., aircraft) in flight operations. Training programs include type rating programs, recurrent programs, and other types of programs. Type rating programs culminate in a certification provisioned to a pilot who successfully completes requirements for training and testing on a specific type of aircraft. Recurrent training programs are designed to enable fulfillment of periodic training requirements for pilots to maintain their certification.

Training programs can include prerequisites for entry, classroom instruction, video lessons, flight training requirements via simulators or aircraft, evaluation of capability for completing particular maneuvers and tasks, written exam requirements, practical test requirements, other requirements, or combinations thereof. Training programs include lessons for normal operation of aircraft, non-normal operation of aircraft, or both. The lessons have objectives that define expected outcomes for the pilot for situations at the completion of a lesson. Lessons are designed to enhance specific pilot competencies and pilot behaviors. Lessons are also designed to be relevant to operational environments such as airport locations, particular flight phases (e.g., take off, approach, landing, etc.), particular terrain, and particular weather conditions. Lessons also address management of threats, errors, and undesired aircraft states. Proficiency associated with particular lessons may be evaluated and quantified based on results of one or more exams, observations made by one or more instructors or evaluators, or combinations thereof.

Guiding principles that inform training programs often pertain to earlier generations of aircraft, are often created as counter responses to incidents, or both. Analysis of incidents can lead to training programs that provide techniques to overcome conditions that caused incidents and can lead to technical improvements to overcome the conditions that caused the incidents. Training programs that provide techniques to overcome conditions that caused incidents can become outdated when technical improvements in subsequent generations of aircraft overcome conditions that previously could cause an incident. Use of training programs based on incidents, based on earlier generations of aircraft, or both, can perpetuate outdated flight training regimes.

Data available for pilots includes data related to pilot training and data related to flight operations. The data related to pilot training and the data related to flight operations can be analyzed and used to determine particular subjects and areas for emphasis in subsequent training.

A system for training program development includes artificial intelligence capabilities, including liquid machine learning algorithms, that enable adaptation to dynamic real world complexity of an aviation environment. The system for training program development determines training programs for pilots based on training of the pilots, flight operations associated with the pilots, monitored conditions encountered by pilots, etc. The system for training program development can also provide content information to training program developers, or people with authorization to hire training program developers. The content information can be associated with content for modification of existing training, content for new training programs, or both. Output of the training program application creates training programs and training program groupings to train pilots to avoid occurrences of certain anomalous states associated with aircraft and to mitigate risks associated with one or more anomalous states that occur due to crewmember actions, weather, aircraft malfunction, other causes, or combinations thereof.

A benefit of use of the system for training program development is enhancement of pilot knowledge, skills, and attitudes of pilots as a result of training programs that are developed for specific flight operational conditions relevant to the pilot. For example, the system for training program development develops first training programs for operators with a group of pilots that fly local routes in a first region having particular atmospheric conditions, terrain, and climatic conditions. The system for training program development develops second training programs for operators with a group of pilots that fly local routes in a second region with different atmospheric conditions, terrain, and climatic conditions than the first region. The system for training program development develops third training programs for another group of pilots that fly routes in the first region and the second region.

A technical advantage of use of the system for training program development is the ability to develop, and put into use, training programs at a fast rate to adapt to changing technology, changing climate conditions, and other dynamic conditions associated with the aviation industry. Another technical advantage is that training programs for pilots are developed that emphasize particular areas and subject matter based on evidence obtained from training environments and flight operation environments in order to enhance the safety posture of the aviation industry.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

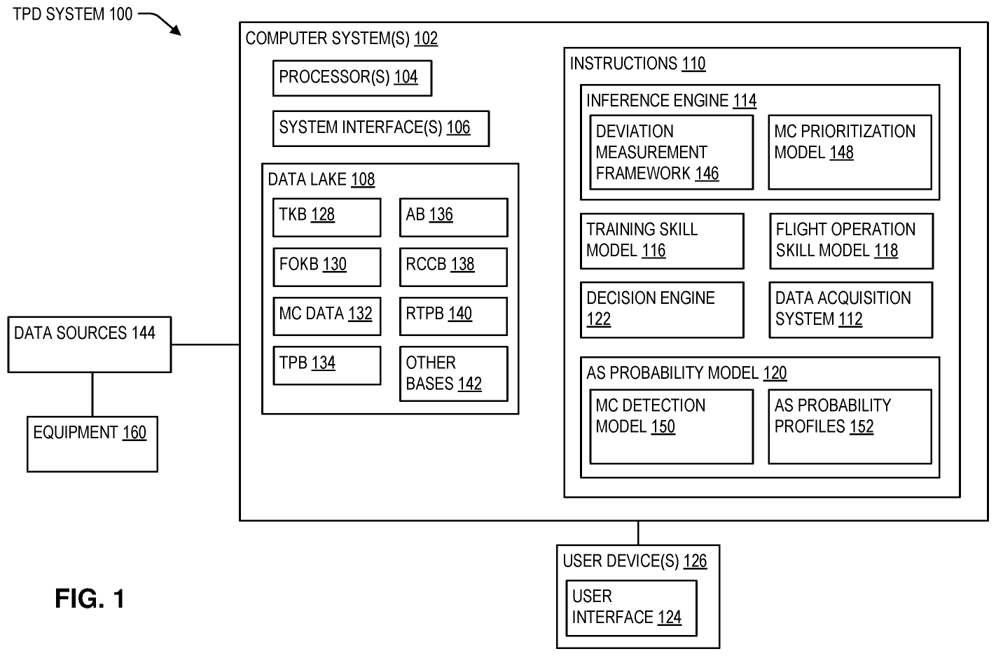

Particular implementations are described herein with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a system 100 including one or more processors (“processor(s)” 104 in FIG. 1), which indicates that in some implementations the system 100 includes a single processor 104 and in other implementations the system 100 includes multiple processors 104. For ease of reference herein, such features are generally introduced as “one or more” features and are subsequently referred to in the singular or optional plural (as indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

As used herein, the term “machine learning” should be understood to have any of its usual and customary meanings within the fields of computers science and data science, such meanings including, for example, processes or techniques by which one or more computers can learn to perform some operation or function without being explicitly programmed to do so (e.g., artificial intelligence). As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, liquid neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows —a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference. In some implementations (e.g., implementations that utilize liquid neural networks), the models are continuously adapted even after training based on the incoming inputs received by the models.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data.” The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 depicts a block diagram of an implementation of a training program development (TPD) system 100. The TPD system 100 includes one or more computer systems 102. The computer system 102 includes one or more processors 104, memory, and a system interface 106. The memory includes a data lake 108 and instructions 110 that are executable by the processor 104 to perform tasks and operations. The instructions 110 are shown for convenience as organized into models, engines, and systems. Such organization is not intended to be limiting. The instructions 110 include a data acquisition system 112, an inference engine 114, a training skill model 116, a flight operation skill model 118, an anomalous state (AS) probability model 120, and a decision engine 122. The TPD system 100 performs tasks associated with developing training programs including generating training programs for pilots, providing recommendations for changes to training courses, adjusting ratings for training courses, or combinations thereof.

The system interface 106 receives user input to perform particular tasks from user interfaces 124 of user devices 126, causes implementation of tasks including the particular tasks and periodic tasks (e.g., determination of updates for particular training courses, adjusting ratings of training courses, etc.), and provides output to the user devices 126. Information provided by the output may be specified in the user input. The system interface 106 includes web interfaces, local interfaces, interfaces to external software to receive requests for information and to provide the information to the external software, other types of interfaces, or combinations thereof.

A particular task based on user input may include determining training programs for members of an entity. The entity may be a group of one or more pilots. The user input may specify information identifying members of the entity by identifying particular pilots; by identifying a particular type of aircraft that members of the entity are certified to operate; by identifying the members as pilots associated with a particular operator (e.g., airline), licensing country, or other group; by identifying particular pilots whose flight routes use one or more particular airports; by identifying other characteristics of the members; or by combinations thereof.

The user input may also specify one or more training topics of interest (e.g., preflight procedures, takeoff, landing, post flight procedures, other topics, or combinations thereof) that the members of the entity are to have training for. The TPD system 100 determines a training program for each member of the entity and provides output that includes a training program for each member of the entity. For example, a training program for a first pilot of an entity would not include a training course that covers a specified topic of interest if the first pilot recently took a training course associated with the specified topic of interest and AS probability profiles for the first pilot generated by the TPD system 100 indicate that the first pilot taking a course that includes the specified topic of interest would not be as beneficial to the pilot as would one or more other training courses included in the training program for the first pilot. A training program for a second pilot of the entity includes a training course associated with the specified topic of interest when AS probability profiles for the second pilot generated by the TPD system 100 indicate that the second pilot taking a training course that includes the specified topic of interest would be beneficial for the second pilot.

The data lake 108 includes data structures (e.g., databases) for storage, retrieval, and access of data used by, and generated by, the TPD system 100. Data storage by the TPD system 100 may be stored in a cloud environment, in public distributed ledgers, private distributed ledgers, to an on-premise database of an operator associated with the data storage, to other types of data storage, or combinations thereof. The data lake 108 includes one or more training knowledge bases (TKBs) 128, one or more flight operations knowledge bases (FOKBs) 130, monitored conditions (MC) data 132, a training program base (TPB) 134, an assessment base (AB) 136, a recommended course change base (RCCB) 138, a recommended training program base (RTPB) 140, and other bases 142.

The TKBs 128 include information related to training taken by pilots received from the training and learning sources. The FOKBs 130 include information about flight operations performed by pilots received from flight operation sources.

The MC data 132 stores identifiers of monitored conditions tracked by the TPD system 100. Monitored conditions may be operation related (e.g., air speed during descent), environmentally related (e.g., weather conditions), airport related (e.g., runway lengths), aircraft related (e.g., malfunctions), maintenance related, air traffic control related (e.g., traffic congestion), or related to other conditions of interest. Some monitored conditions occur as a result of crew actions or inactions. Other monitored conditions occur beyond the influence of crews and are managed by crews to operate aircraft effectively and efficiently. Mismanagement of monitored conditions can lead to an anomalous state.

The TPB 134 includes information about training courses available to pilots. The TPB 134 may include an identifier associated with a course, course content and learning objectives, intended audience, available language(s) for the course, availability information for a course, prerequisites for the course (e.g., employee of a particular operator, certified to operate a particular type of aircraft, etc.), course provider, development date associated with the course, update content and update dates, an overall rating and topic ratings associated with the course, and other information associated with the course. The intended audience for a course may vary. For example, a third party training provider or aviation oversight entity that operates at a global level may produce training courses that reflect a global standard; a civil aviation authority may produce a training course that is specific to region and country characteristics; and an operator may produce a training course that is specific to particular pilots or groups of pilots or that is specific to a route structure of the operator and operational environment. As another example, an original equipment manufacturer (OEM) may produce training courses specific to fleets of aircraft, specific to new equipment for aircraft or new aircraft, specific to new procedures, or combinations thereof.

If a course identified in the TPB 134 is updated, appropriate modification to database entries for the course content, development date, other information, or combinations thereof, may be made to reflect the update to the course. Alternatively, a termination date for the course is entered in the TPB 134 and new entries are made in the TPB 134 for the updated course, including a new identifier for the updated course.

The AB 136 includes evaluations of skills for each pilot. The AB 136 may include data generated by the training skill model 116, including a record of pilot training and training performance over time and a score for each pilot for each monitored condition included in the MC data 132. The AB 136 may also include data generated by the flight operation skill model 118, including a record of pilot performance over time and a score for each pilot for each monitored condition included in the MC data 132.

The RCCB 138 includes output of the decision engine 122 that includes recommendations for changes to existing training courses, recommendations for new training courses, or both. Recommendations for training course changes can be based on a development date of the training course, content of the training course, a rating associated with the course, available aircraft updates, analysis of the flight operation data for people who took a training course, other information, or combinations thereof.

The RTPB 140 includes output of the decision engine 122 that specifies training courses that pilots should take. Entries in the RTPB 140 can include a training program for individual pilots of a group of one or more pilots of an entity identified by user input from the user device 126.

The other bases 142 may include other information utilized by the TPD system 100. The other bases 142 include airport databases, weather databases, personnel databases, aircraft performance and maintenance databases, and a safety database. The airport databases include information about airports including a number of runways, runway lengths, etc. The personnel databases store, on a per person basis, information about pilots, the aircraft(s) pilots are type rated on, pilot demographics, and other information associated with pilots. The aircraft performance and maintenance databases store flight information extracted from data streams of the aircraft maintenance source. Example flight information in the aircraft performance and maintenance databases includes aircraft information, environment information, air traffic control information, aeronautical operational control information, and operator administrative control information. The safety database stores safety related records from the record source. Example flight information stored in the safety database includes safety information about the aircraft, environment, line operational safety audits (LOSA), International Air Transport Association (IATA) operational safety audits (IOSA), undesired event statistics, and incident statistics.

The data acquisition system 112 monitors a plurality of data sources 144 to detect new data relevant to the TPD system 100. When new data is detected, pointers to the new data, the new data, or both, are stored in appropriate data structures in the data lake 108. The data sources 144 include training and learning sources, flight operation sources, crew data sources, aircraft maintenance sources, weather sources, record sources, operator sources, aircraft manufacturer sources, other sources, and combinations thereof.

The training and learning sources provide data pertaining to available courses, course content, instructors of courses, courses taken, assessments of course takers, other information, or combinations thereof. The flight operation sources provide data pertaining to operation of aircraft, such as sensor readings, pilot actions (e.g., maneuvers, procedures, approaches, and landings), and activities that support a flight. Pilots manage the flight path and control the aircraft to move passengers and cargo from one point to another. Control of the aircraft can be manual control, machine assisted control, or machine control (e.g., autopilot). The flight operations sources receive data from equipment 160 (e.g., aircraft). The flight operations sources store raw flight data, which may include records of thousands of flight parameters such as speed, velocity, attitude, flap settings, thrust settings, acceleration, etc., for an entire flight. The crew data sources provide information associated with flights. The data includes type of aircraft for a flight and the crew members that flew the flight.

Aircraft maintenance sources store maintenance records of aircraft. The aircraft maintenance source store information about tasks performed to ensure the continuing airworthiness of an aircraft or aircraft parts. Tasks generally pertain to compliance with airworthiness directives and rework. The tasks may include inspection, part replacement, issue rectification, alarm monitoring instigated by humans or computer systems of aircraft, system tests, installation of system updates, or other maintenance functions. The aircraft maintenance source may record aircraft communications addressing and reporting system (ACARS) sensor data from the aircraft, which includes technical performance and aircraft system status data.

The weather sources store weather information pertaining to flight operation environments. The weather sources includes systems and sensors for weather tracking during flights. For example, the weather sources include systems and activities to provide enroute aircraft weather radar and regional airport weather, global satellite imagery of weather activity (visible and infrared), global text reports of weather, and global forecasts including but not limited to turbulence, icing, visibility, precipitation, wind, and lightning, and other weather-related information. The weather sources output a data stream that includes weather images, advisories and reports, and forecasts.

The record sources store pilot information including first name, last name; demographics, and qualifications for each pilot. The qualifications may include but are not limited to aircraft type ratings, other type ratings such as pilot in command or second in command, total flight hours, degrees, degree institutions, medical certifications, and certification institutions. The record source may further store information for a pilot including hire date, place of residence, country of origin, languages spoken, nationality, medical qualifications, and countries of citizenship. The data stream may include digital images of paper-based records, digital text record, digital images of paper-based certificates, digital certificates, and digital records.

Operator sources provide rules associated with the particular operators and information about operating procedures associated with particular operators (e.g., airlines). The rules may identify particular training courses that all pilots, or groups of pilots, are required to take by a particular operator. The information about operating procedures may vary among different operators. Aircraft manufacturer sources provide information about new features available for aircraft, standard operating procedures, standard operating procedure changes for aircraft operation, changes associated with maintenance for aircraft, and other information available from aircraft manufacturers. The information from aircraft manufacturers can be adapted by an operator to develop standard operation procedures for each type of aircraft to produce fleet-specific information in the form of thresholds, procedures, instructions, and guidance on how to operate a type of aircraft under normal and non-normal conditions. The fleet-specific information of each operator is part of the data lake 108.

Various components of the data lake 108 may be maintained by distinct business entities and have heterogenous storage structures. For example, the TKBs 128 may be managed and owned by multiple operators, original equipment manufacturers (OEMs), and training providers; the safety databases may be managed and owned by regulatory entities, operators, and data aggregators; weather databases may be managed and owned by governmental entities and operators; personnel databases may be managed and owned by multiple operators; and aircraft performance and maintenance databases may be managed and owned by multiple operators, OEMs, and service providers.

The inference engine 114 contains business rules used by the TPD system 100. The inference engine 114 includes a deviation measurement framework 146 that enables determination of values for degrees of separation of performance from expected performance and a monitored condition prioritization model 148.

Deviations determined by the deviation measurement framework 146 include actions, or lack of actions, by pilots that are alternatives to an intended action. Examples of deviations can pertain to the handling of aircraft (e.g., manual handling) which can be measured through aircraft sensors and parameters (e.g., non-standard flap settings and vertical, lateral, and speed deviations). Deviations may also be procedural in nature. For example, performing items in a checklist in a non-standard manner and non-standard documentation of fuel, weight, and balance information can be identified as deviations from standard operating procedures. Examples of communication deviations can be non-standard runway and taxi specifications. Deviations can be antecedents to anomalous states.

The monitored condition prioritization model 148 enables organization of applicable monitored conditions of the MC data 132 in a priority order based on a plurality of factors, including present state of monitored conditions (e.g., normal state or anomalous state); rate of occurrence of monitored conditions for a pilot, operator, region, or country; training course content, flight operation conditions; monitored condition impact, which are based on additional rules; etc. In some implementations, the monitored condition prioritization model 148 determines status of the monitored conditions and a cause of a monitored condition that is in an anomalous state. The cause may be attributed to a pilot, a crew, an aircraft (e.g., a failed system), environmental conditions, or combinations thereof. The status of a monitored condition, the cause of a monitored condition, the priority of a monitored condition, or combinations thereof, can change with passage of time for a flight operation or a simulated flight operation. For example, at a particular time an anomalous monitored condition (e.g., a heading during approach changes) is determined to be present and rules of the monitored condition prioritization model 148 determine the cause to be environmental conditions. Based on rules of the monitored condition prioritization model 148, the priority of the monitored condition is increased and the cause of the anomalous state is subsequently changed to attribute at least a portion of the cause to the pilot if the monitored condition is not corrected in a particular time frame.

For some operations, the inference engine 114 applies a forward chaining method to identify rules where an antecedent is known to be true. As an example, for a first entry of a number of flight hours that is greater than a particular threshold (i.e., 30,000 hours), the output of the inference engine 114 is a first set of rules associated with experienced pilots, while for a second entry of a number of flight hours less than the particular threshold, the output of the inference engine 114 is a second set of rules associated with less experienced pilots, where the first set of rules are different than the second set of rules.

For some operations, the inference engine 114 forward chains the TKB 128 and the FOKB 130 to deduce consequents of pilot and crew actions from training environments and flight operations environments. Example IF antecedent logic contained in the inference engine 114 may pertain to pilot and crew actions for managing monitored conditions and manipulating simulators. Example THEN consequent logic in the inference engine 114 may pertain to pilot ability to mitigate an anomalous state.

In a training environment and in operations environment, outputs of the inference engine 114 include rules for scoring. Training skill scores may be deduced by a number of factors in the training program that define a degree of separation from predicted performance associated with a monitored condition to expected performance associated with the monitored condition for each lesson and for various training exams. Operation skill scores may be deduced by a number of factors during operation that define a degree of separation from actual performance with respect to monitored conditions that occur, or are likely to occur, to expected performance with respect to the monitored conditions that occur, or are likely to occur. Rules may consist of logic for competency, behavior, task, and other types of scores. For example, during a simulation, IF a pilot sets flap controls, THEN sets x then sets y, which is the expected performance of the pilot, THEN the score is 5, while IF the pilot sets flap controls, THEN sets y then sets x, THEN the score is 1, and the score is −5 if the pilot does not set x and y. In other implementations, other scoring rubrics are used.

The inference engine 114 contains rules for geographic conditions (e.g., terrain) and weather. The rules are leveraged by the decision engine 122 to develop training programs specific to an operator, a group, or an operational environment. Geographic conditions may also be classified by characteristics of route structures.

The training skill model 116 normalizes training data from the TKB 128. Algorithms of the training skill model 116 use the deviation measurement framework 146 of the inference engine 114 to deduce a degree of deviation from standards obtained from the inference engine 114. The training skill model 116 uses artificial intelligence methods, such as liquid machine learning, to classify outcomes of training and create training skill scores for the monitored conditions indicated by the MC prioritization model 148 of the inference engine 114. Training skill scores are determined at least for monitored conditions associated with learning objectives for a taken training course.

A training skill score for a pilot for a monitored condition depends on the monitored condition, industry standards of evaluation of the monitored condition, other factors, or combinations thereof. Training skill scores for some monitored conditions may be numeric values on a particular scale (e.g., a 5, 6, 7, or some other point scale). Training skill scores for other monitored conditions may be one or more logical values, one or more non-numeric values, multiple numeric values, another type of score, or combinations thereof. In some implementations, a training skill score for a monitored condition associated with a procedure indicates if and how well the procedure was performed relative to an expectation during training. For example, a training skill score of 0 for a pilot may indicate that the procedure was not performed during a simulation, a training skill score of 1 for the pilot may indicate that the procedure was performed poorly during the simulation, and a training skill score of 4 for the pilot may indicate that the procedure was performed well during the simulation. The training skill score for the procedure indicates how well the procedure was performed during training, which corresponds to whether a likelihood of exposure to an anomalous state associated with the procedure during flight operations has increased or decreased based on expected actions of the pilot based on the training.

For some training skill scores, a training skill score of a base number (e.g., zero) indicates an expected performance for a monitored condition covered in a training course. Expected performance that is worse than the expected performance may be indicated by a number that is less than the base number, and an expected performance that is better than the expected performance, if such a performance is possible, may be indicated by a number that is greater than the base number. In other implementations, an expected performance that is worse than the expected performance is indicated by a number that is greater than the base number, and an expected performance that is better than the expected performance, if such a performance is possible, may be indicated by a number that is less than the base number. A training skill score may be adjusted due to the passage of time from when a training course that emphasized the training skill was taken to reflect that a pilot may be less likely to produce an expected performance when the training skill has not been recently emphasized. The training skill scores are stored in the AB 136 and are used as input to the AS probability model 120.

The training data received by the training skill model 116 from the TKB 128 includes training outcome data from instructor-led training environments and digital training environments. The training skill model 116 indexes the training skill data in time order. Training skill data older than a threshold time (e.g., 3 years, 2.5 years, 2 years, or some other threshold time) may be ignored. The training outcome data includes pass/fail results; tested/retest items; instructor observations; computer deduced ratings of learner execution of maneuvers, procedures, and tasks; data from flight simulators; instructor and computer inferred levels of competence scores and behavior observation scores, topic scores, overall course scores, other information, or combinations thereof.

The training data is normalized. Different providers of training and assessment have varying operations and standards for performing training and assessment. The training skill model 116 includes machine learning capabilities that normalize training data across the different providers.

The training skill model 116 uses the deviation measurement framework 146 of the inference engine 114 to determine a degree of deviation from training performance for a pilot from expected training performance for the pilot as training skill scores. The training skill scores include values that indicate likelihood of causing an anomalous state for the monitored conditions and values that indicate likelihood of an appropriate response to anomalous states for the monitored conditions. Rules pertaining to pilot training performance and standards are obtained from the inference engine 114. The rules are defined in scoring rubrics based on course content, normalized course scores, passage of time since completion of the course, flight simulator data, other factors, or combinations thereof. The training skill model 116 includes a training results aggregator. The training results aggregator aggregates training associated with a particular pilot identified by a unique pilot identifier in the TPD system 100 to show a longitudinal record of pilot training and training performance over time. Output of the training skill model 116, including training skill scores and the longitudinal record of pilot training and training performance, is stored in the AB 136. The training skill scores of the output of the training skill model 116 are used as input to the flight operation skill model 118, the AS probability model 120, or both.

The flight operation skill model 118 normalizes training data from the FOKB 130. Algorithms of the flight operation skill model 118 use the inference engine 114 to determine flight operation skill scores. The flight operation skill model 118 uses artificial intelligence methods, such as liquid machine learning, to classify outcomes of phases of flight operations and create flight operation skill scores for monitored conditions indicated by the MC prioritization model 148 of the inference engine 114. The flight operation skill scores include values indicating causation of anomalous states associated with monitored conditions, and values for handling anomalous states associated with monitored conditions.

Similar to the training skill scores, flight operation skill scores depend on the monitored condition, industry standards of evaluation of the monitored condition, other factors, or combinations thereof. A scoring rubric used to determine a training skill score for a monitored condition may also be used to determine a corresponding flight operation skill score for the monitored condition so that a basis for a training skill score for a monitored condition and a corresponding flight operation skill score for the monitored condition is the same. Flight operation skill scores may be determined for each monitored condition that occurred, or had a significant probability of occurring (e.g., greater than a 40% chance of occurring, greater than a 50% chance of occurring, or greater than some other chance of occurring) but for one or more actions of the crew during a flight. Null values may be indicated for the remaining monitored conditions. For example, for a flight that departed from an airport located in a tropical climate during the summer, a value(s) for a monitored condition associated with a preflight icing procedure is set to a null value(s) since a preflight icing procedure would not be necessary for the flight.

The flight data received by the flight operation skill model 118 from the FOKB 130 includes flight operations data. The flight operation data and information from crew data sources are analyzed to associate pilots that flew a flight with the flight data for the flight. The flight operation skill model 118 indexes the flight operation data in time order and normalizes the data (e.g., converts units to metric system units when not provided in metric system units). Flight operation data older than a threshold time (e.g., 3 years, 2.5 years, 2 years, or some other threshold time) may be ignored.

The flight operation skill model 118 uses the deviation measurement framework 146 of the inference engine 114 to determine a degree of deviation from flight operation performance for a pilot from expected flight operation performance for the pilot as flight operation skill scores. Rules pertaining to flight operation performance and standards are obtained from the inference engine 114. The rules are defined in scoring rubrics based on flight experience, causation, and other factors. The flight operation skill model 118 includes a flight operations aggregator. The flight operations aggregator aggregates flight operation performance associated with a particular pilot identified by a unique pilot identifier in the TPD system 100 to show a longitudinal record of pilot flight performance over time. Output of the flight operation skill model 118, including flight operation skill scores and the longitudinal record of pilot performance over time, are stored in the AB 136. The flight operation skill scores of the flight operation skill model 118 are used as input to the AS probability model 120.

The AS probability model 120 determines, based on flight training skill scores, flight operation skill scores, and the monitored conditions of the MC data 132, a likelihood, a consequence, and severity of monitored conditions on a pilot basis, operator basis, region basis, country basis, global basis, or other basis. In some implementations, the consequence is a change to one or more other monitored conditions. In some implementations, the severity may be based on a scale with different values for no impact to flight operations, low impact to flight operations, medium impact to flight operations, or high impact to flight operations. The AS probability model 120 predicts an anomalous state based on forecasts and projections.

Anomalous states are states that are outside of normal operation. Anomalous states may be induced by crew actions, lack of crew actions, or may occur beyond crew control (e.g. engine failure). Anomalous states can occur in training environments and in flight operations. Some anomalous states can be due to aircraft handling (e.g., unauthorized airspace penetration, long landing, unstable approach, etc.), ground navigation (e.g., non-standard taxiway usage and proceeding towards a non-standard runway), aircraft configuration (e.g., non-standard flight controls and system configurations), mismanaged monitored conditions, other causes, or combinations thereof. Anomalous states are known to be antecedents to incidents.

The AS probability model 120 performs anomalous state probability analysis to assess safety including prediction of actions resulting in anomalous states and infrastructure issues by capturing a holistic picture of operator and global anomalous state probabilities. The anomalous probability analysis is performed through assessment of human performance in a broad set of training environments, human performance in flight operations, human performance under given environmental conditions, and considering aircraft factors as examples. The AS probability model 120 operates in a feedback loop with the decision engine 122 to provide better recommendations and estimations of anomalous state probability. The AS probability model 120 includes a monitored condition (MC) detection model 150 and anomalous state (AS) probability profiles 152. The AS probability model 120 conducts anomalous state probability assessments to predict situations that could affect aviation safety and to draw conclusions about the appropriate anomalous state probability treatment strategy based on the current training associated with the pilot being analyzed.

Inputs to the AS probability model 120 include output of the training skill model 116 and the flight operation skill model 118, and data for aircraft and a pilot from the data lake 108. The AS probability model 120 processes data for a pilot of a group of one or more pilots (e.g., an entity). Output of the AS probability model 120 includes an anomalous state probability profile of the AS probability profiles 152 based on a current level of training and operational performance for a pilot being analyzed, and additional probability profiles of the AS probability profiles based on the pilot being analyzed having additional training from one or more training courses from the TPB 134 provided to the AS probability model 120 by the decision engine 122. The AS probability profiles 152 specify, for the pilot, a likelihood, severity, and consequences of monitored conditions. Based on the AS probability profiles 152, the training skill scores, and the flight operation skill scores, the decision engine 122 determines a training program for the pilot that reduces the likelihood, severity, and consequences of monitored condition occurrence.

The MC detection model 150 includes at least one machine learning model that determines a likelihood of a monitored condition occurrence for a monitored condition defined in the MC data 132, which would result in an anomalous state. Adding additional monitored conditions to the MC data 132 and determinations of additional monitored condition by the MC detection model 150 may be performed using supervised learning. A selection of features for a monitored condition is based on a type of the monitored condition. For example, if the monitored condition type is a failure of the aircraft, and the MC detection model 150 does not consistently identify the monitored condition, the MC detection model 150 can add additional features closely related to the aircraft to the definition of the monitored condition in the MC data 132 to consistently identify the monitored condition.

The MC detection model 150 further includes functionality to detect patterns that pertain to pilot behaviors and operations of an aircraft. The MC detection model 150 may include a classifier model, such as a Bayesian classifier or a neural network, that extracts multiple features from the various input data to match the input data to output classes. The output classes are the possible monitored conditions that may occur. The MC detection model 150 combines the likelihood of the monitored condition with a severity of the monitored condition and an output consequence. In some cases, the severity of the monitored condition may be determined by a rule based model, the monitored condition may have a predefined severity level, or the severity level of the monitored condition may be the output of the machine learning model. The severity level may be adjusted based on occurrence of one or more additional monitored conditions.

Output of the AS probability model 120 includes metrics. The metrics include errors per million aviation threats (E-MATs). E-MATs is a ratio of errors produced by a pilot or group of pilots, which are aggregated for training environments and flight operations, to a number of aviation threats expressed in errors per million aviation threats. The metrics also include predicted errors per million aviation threats (PE-MATs), mitigated threats per million aviation threats (MT-MATs), predicted mitigated threats per million aviation threats (PMT-MATs), undesired aircraft state per million aviation threats (UAS-MATs), and predicted undesired aircraft state per million aviation threats (PUAS-MATs). The AS probability model 120 determines sufficiency of a crew to mitigate an anomalous state. The sufficiency to mitigate an anomalous state is based on deductions from the training skill scores and previous mitigation of the same anomalous state or a similar anomalous state determined from flight operation data. Output from the AS probability model 120 is provided to the decision engine 122.

The decision engine 122 provides output based on received user input received via the system interface 106. The output can include training programs for members of an entity identified in the user input. Additional information included in the output can include flight operation readiness information for members of the entity and the entity, areas of compliance and non-compliance with training rules for members of the entity, crew pairing information, other information, and combinations thereof.

The decision engine 122 contains decision logic and runs decision services to automatically make decisions regarding the design of training program for individual pilots or groups of pilots identified by user input via the system interface 106. In addition to developing a training program for each member of an entity, the decision engine 122 provides an analysis of readiness of each pilot for additional flight operations and readiness of the entity for flight operations based on the AS probability profiles 152 and aggregations of the AS probability profiles 152 for the entity. Readiness of the pilot or the entity is based on historic AS probability profiles 152, currently determined AS probability profiles 152, preparedness scores for the pilots, a maturity estimation (e.g., a timeframe to build requisite skills to for satisfactory live flight operations), composite AS probability scores, or combinations thereof. When the entity is a group of pilots, the decision engine 122 can provide a crew scoring associated with pairs of pilots of the group. Pairs of pilots can be chosen so that the capabilities of a pilot pair as evidenced by skill scores of the pilots are complementary.

The training program for a pilot can include mandatory training courses that a pilot has to take (e.g., training courses required by an entity such as an operator or an aviation authority) and recommended training courses determined by the TPD system 100 based on training skill scores output by the training skill model 116, based on flight operation skill scores output by the flight operation skill model 118, output of the AS probability model 120, or combinations thereof. The output of the decision engine 122 provided to a visual display can include indicia (e.g., color, highlighting, bold font, italic font, etc.) that distinguishes mandatory training courses from recommended training courses. Output of the decision engine 122 can be saved to the RTPB 140, output to a display screen indicated by input data received via the system interface 106, or both. The training program recommended for a pilot can include one or more courses identified in the TPB 134 that are available for the pilot and that cover topics for which the pilot should have additional training.

The training program for a pilot output by the decision engine 122 can include courses based on training skill scores that indicate an additional need for training and that are applicable to the pilot. For example, a training skill for preflight icing procedures may be low, which would indicate a need for additional training, but if other data for the pilot (e.g., flight routes) indicates that the pilot does not encounter preflight icing conditions, the training program would not include a first training course that includes a topic of preflight icing procedures only for the presence of the topic of preflight icing procedures because the topic is not relevant to the pilot. The first training course could be included in the training program if the flight operation skill scores or the analysis of the AS probability profiles 152 for the pilot indicate that the first training course should be taken by the pilot due the inclusion of one or more other topics in the first training course or if the first training course is a mandated course for a group of pilots that includes the pilot. Similarly, the training program can include training courses based on flight operation skill scores that indicate an additional need for training courses related to one or more particular topics, and can include training programs based on the output of the AS probability model 120.

The flight operation skill scores may be utilized by the decision engine 122 in determining whether to include one or more training courses in the training program. For example, a particular flight operation skill score (e.g., a flight operation skill score associated with turning maneuvers) for a pilot is a value that exceeds expected performance and a trend of the flight operation skill indicate that the value has decreased over a time period (e.g., one year) at a rate that exceeds an expected decrease rate, the decision engine 122 can include a training course that includes the topic of turning maneuvers in the training program for the pilot based on the flight operation skill score even though the turning maneuver performance for the pilot is rated as better than expected performance.

The decision engine 122 may use a statistical model to determine a frequency of actions and severity of resultant consequences to determine training courses needed for the pilot. Courses determined by the decision engine 122 seek to minimize mismanagement of monitored conditions and negative deviations from expected behavior. In some embodiments, the output of the decision engine 122 identifies non-compliance areas of training for the pilot and generates a report in a regulatory format identifying compliance and non-compliance areas.

In addition, the decision engine 122 includes decision structure that provides content recommendations to update training courses or content for new courses to third party course providers, to particular people with authority over training courses, or both. The decision engine 122 may recommend development of one or more new courses when a number of pilots need training in particular topics in one or more related subject areas that are not available to the pilots or are available in several training courses instead of one or more training courses directed to the particular topics of the one or more related subject areas. The content recommendations for a training course may be based on comments of one or more people (e.g., instructors not associated with the training course) who take the training course, analysis of flight operation skill scores produced by the flight operation skill model 118 for a group of pilots who took the training course prior to taking the training course and after taking the training course, availability of updates associated with topics covered by the course, other determinations, and combinations thereof. The content recommendations are stored as data in the RCCB 138.

The decision engine 122 includes decision structure that evaluates training courses in the TPB 134 and modifies rankings associated with the training courses. Evaluation of a training course is based on reviews of the training course by people (e.g., instructors not associated with the training course), when the training course was developed, updates to the course, updates available for topics covered in the training course, analysis of flight operation skill scores produced by the flight operation skill model 118 for a group of pilots who took the training course prior to taking the training course and after taking the training course, other determinations, or combinations thereof. Should a recommendation to update a training course in the RCCB 138 be ignored, the ranking for the course will decrease and eventually become lower than a threshold rating for training courses that the TPD system 100 can recommend.

Advantages of using the TPD system 100 include providing training programs for pilots based on current and relevant data from training environments and flight operation environments. Providing training programs based on training environments, flight operation environments, and current generations of aircraft provides training programs that enhance a safety posture of the aviation industry and adapt to changing conditions (e.g., climate changes, pilot skill levels, technological changes, etc.). The TPD system 100 enhances knowledge, skills, and attitudes of pilots as a result of training programs that are generated for specific flight operational conditions relevant to the pilot.

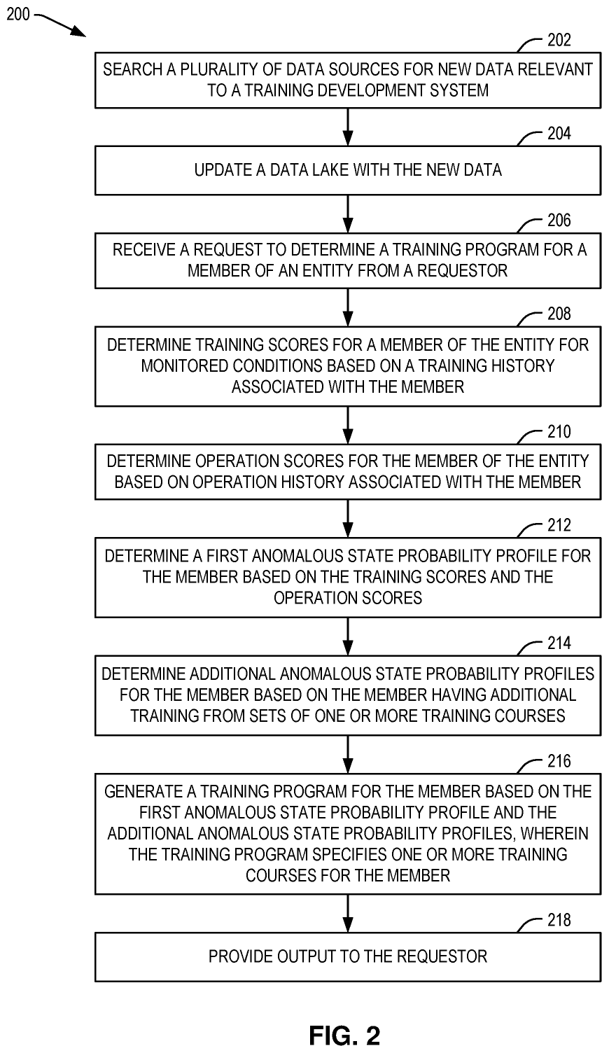

FIG. 2 is a flow chart of a method 200 of generating training programs. The method 200 can be implemented, performed, or controlled by the computer system 102 of FIG. 1. The method 200, at block 202, includes searching a plurality of data sources 144 for new data relevant to a TPD system 100. New data relevant to the TPD 100 may include data associated with training courses taken by one or more pilots, flight operation data associated with one or more pilots, new pilot data, data associated with one or more pilots (e.g., change of employer, new certification for an aircraft, change of demographic information, etc.), maintenance data associated with aircraft, data associated with new and updated training programs, updates to flight procedures, weather data, incident data associated with aircraft, updated training requirements for one or more operators or countries, etc.

The method 200, at block 204, includes updating a data lake 108 with the new data. The data lake includes data structures for data relevant to the TPD system 100. In some implementations, the data structures include a training knowledge base 128 for data corresponding to training of pilots, and a flight operations knowledge base 130 for flight operation data associated with flights piloted by the pilots.

The method 200, at block 206, includes receiving a request to determine training programs for a member of an entity. In an implementation, the request is received at the system interface 106 from the requestor via the user interface 124 of the user device 126. The requestor is a pilot, person associated with an operator, or other person with authority to request training programs from the TPD system 100. Members of the entity are one or more pilots identified by the requestor. The entity may be designated by providing identification of one or more particular pilots, by designating particular characteristics of a group of one or more pilots, or both. The characteristics can include certifications to operate a particular type of aircraft, employees of a particular operator, pilots certified by a particular aviation authority, pilots whose routes use one or more identified airports, pilots with less than a particular number of flight hours, other characteristics, or combinations thereof. Members of the entity are determined by analysis of data from multiple sources available in the data lake 108.

The method 200, at block 208, includes determining training skill scores for a member of the entity based on a training history associated with the member. The training skill scores indicate a deviation of predicted performance of the pilot from a base predicted performance. The inference engine 114 includes standards for the base predicted performance. The training history is retrieved from the training knowledge base 128. The training skill scores are generated by the training skill model 116. The training skill model 116 creates maps of attributes for the member to assess the predicted performance of the member relative to expected performance of the member. Based on data from the TKB 128 for training activity and learning environments, the training skill model 116 determines attributes associated with classifications including skill attributes, behavioral indicator attributes, course attributes, monitored condition attributes, deviation attributes, anomalous state attributes, undesired event attributes, incident attributes, other attributes, or combinations thereof.

The training skill model 116 utilizes the attributes and the inference engine 114, including the deviation measurement framework 146, to determine values for training skill scores corresponding to monitored conditions. Factors included in determining training skill scores include learning objectives defined for each training course, one or more skill scores for a type rating course, one or more skill scores for each recurring training course taken, competency response to introduction of one or more anomalous conditions (e.g., was sequence of pilot actions during a simulated flight an appropriate response and did the response lead to an acceptable outcome within applicable aircraft handling safety margins), competency indicator scores for tasks, competency indicator scores for procedures, competency indicator scores for maneuvers, behavioral indicator scores for tasks, behavioral indicator scores for procedures, behavioral indicator scores for maneuvers, etc. In addition to the training skill scores generated by the training skill model 116, the training skill model 116 also prepares a lateral history of training for the member, including type rating courses and recent training for the member. Output of the training skill model 116 is saved in the AB 136 and provided to the AS probability model 120, the decision engine 122, or both.

The method 200, at block 210, includes determining operation skill scores for the member of the entity based on operation history associated with the member. The operation history is retrieved from the FOKB 130. The operation skill scores are generated by the flight operation skill model 118. The flight operation skill model 118 creates maps of attributes to enable assessment of pilot performance relative to expected performance. Based on data from the FOKB 130 for flight operation environments, the flight operation skill model 118 determines attributes associated with classifications including skill attributes, competency indicator attributes, behavioral attributes, activity attributes, flight phase attributes, flight route attributes, deviation attributes, anomalous state attributes, undesired event attributes, incident attributes, other attributes, or combinations thereof.

The flight operation skill model 118 utilizes the attributes and the inference engine 114, including the deviation measurement framework 146, to determine values for flight operation skill scores corresponding to monitored conditions. The flight operation skill scores indicate deviations of actual performance from the base predicted performance. In addition to the flight operation skill scores generated by the flight operation skill model 118, the flight operation skill model 118 also prepares a lateral history of flight operation performance comparative to the base predicted performance. Output of the training skill model 116 is saved in the AB 136 and provided to the AS probability model 120, the decision engine 122, or both.

The method 200, at block 212, includes determining a first anomalous state probability profile for the member based on the training skill scores and the operation skill scores. In some implementations, the AS probability model 120 determines the first anomalous state probability profile of the AS probability profiles 152 based on the training skill scores and the operation skill scores. The method 200, at block 214, includes determining additional anomalous state probability profiles for the member based on the member having additional training from sets of one or more training courses. In an implementation, the decision engine 122 determines the sets of one or more training courses using a plurality of rules that are based on the training skill scores, the operation skill scores, prerequisites for the training courses, emphasis of one or more topics in the training courses, location of the pilot, availability for the pilot to actually take the training course, other considerations, or combinations thereof. Each set can include one or more training courses that emphasize training in areas where the training skill scores, the flight operation skill scores, or both, indicate a need for additional training. The decision engine 122 causes the training skill model 116 to generate new training skill scores as if the member recently took and passed the training course(s) of a set of the sets, and output from the training skill model 116 for the set is provided to the AS probability model 120 to generate an additional AS probability profile of the of the AS probability profiles 152.

The method 200, at block 216, includes generating a training program for the member based on the first anomalous state probability profile and the additional anomalous state probability profiles, wherein the training program specifies one or more training courses for the member. In an implementation, the decision engine 122 analyzes the AS probability profiles 152 and determines the set of training programs that results in a low probability of mismanagement of monitored conditions and a low probability of negative deviations from expected behavior.

The method 200, at block 218, also includes providing output to the requestor. The output includes a training program for each member of the entity, at least a portion of a training history for each member of the entity, at least a portion of operation performance over time, or combinations thereof. A training program for each member of the entity is provided as output. The output of the decision engine 122 can also include readiness for flight operations, a regulatory report of training compliance, crew pairing information, etc., associated with each member of the entity, the entity, or both.

More, fewer, and/or different steps can be included in the method 200 without departing from the scope of the subject disclosure. For example, the method 200 can vary depending on a type of output requested by the requestor. For example, when the requestor is a pilot, the entity may include only the pilot and may simply request an applicable training program for the pilot. When the requestor is an employee associated with pilot compliance with training requirements, operation safety, etc., the requestor may request training programs for a group of pilots, may request training compliance information associated with the pilots of the group, and readiness information associated with the individual pilots and the group.

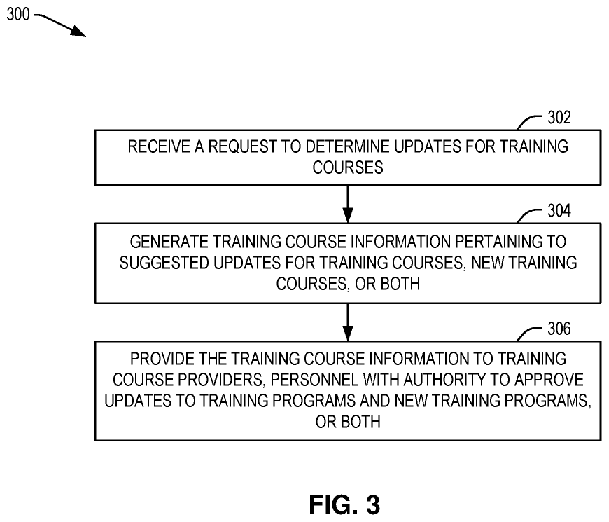

FIG. 3 is a flow chart of a method 300 of an implementation of use of a training program development system. The method 300 can be implemented, performed, or controlled by the computer system 102 of FIG. 1. The method 300, at block 302, includes receiving a request to determine updates for training courses. In an implementation, the request to determine updates may be periodically generated by the processor 104, may be received from a user device 126 via the system interface 106, or both. In some implementations, the request to update causes the computer system 102 to update training course scores associated with courses in the TPB 134. The courses can be updated based on passage of time, based on new rating information for training courses received from one or more people with appropriate knowledge to evaluate the training courses, based on other information, or combinations thereof.

The method 300, at block 304, includes generating training course information pertaining to suggested updates for training courses, new training courses, or both. The course information is based on dates when training courses were developed or last updated, based on ratings for the training courses and topics covered by the training courses made by people with the appropriate knowledge to evaluate the training courses and topics, procedure change information determined from the data lake 108, availability of a training course or portions of a training course in a first language but not in a second language, implemented or soon to be implemented technological improvements, a determination based on generated training programs of a need for a training course that covers particular topics that are frequently needed by pilots, determination that one or more topics of particular training programs are not needed or out of date, other information, or combinations thereof. The training course information includes topics of existing training courses that need to be updated, references to updated material for the existing training courses, topics for one or more new training courses, references to material for the one or more new courses, other information, or combinations thereof. The training course information is saved to the RCCB 138.

The method 300, at block 306, also includes providing the training course information to training course providers, personnel with authority to approve updates to training programs and new training programs, or combinations thereof. When the rating for a particular course or portions of a particular course is below a threshold rating, the training course information can also include a notification to the producer of the training course that the training course will not be included in training programs for pilots that need training taught by the course or the topics of the course, due to a low overall course rating or a low course rating for particular course topics.

In addition to providing training course information to training course providers, personnel with authority to approve updates to training programs and new training programs, or combinations thereof, the training course information can be provided to one or more entities that do not develop training courses or do not primarily develop training courses (e.g., OEMs). For example, the training course information can be provided to regulators, OEMs, safety entities, other entities, or combinations thereof, that are associated with training program standards.

More, fewer, and/or different steps can be included in the method 300 without departing from the scope of the subject disclosure. For example, the method 300 can be performed without providing a notification associated with a low rating for a training course to the producer of the training course.

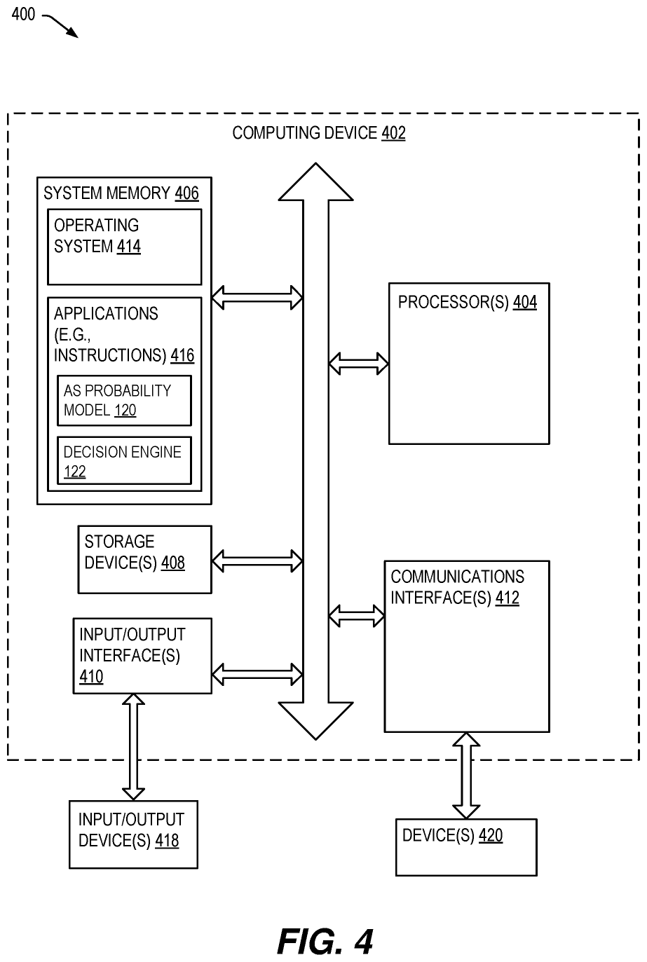

FIG. 4 is an illustration of a block diagram of a computing environment 400 including a computing device 402 configured to support implementations of computer-implemented methods and computer-executable program instructions (or code) according to the present disclosure. For example, the computing device 402, or portions thereof, may execute instructions to perform, or cause equipment to perform, operations described with reference to FIG. 1 and FIG. 2. In implementations, computing devices 402 are, or are components of, the computer systems 102, the data sources 144, the data lake 108, and the user devices 126 of FIG. 1.

The computing device 402 includes one or more processors 404. The processor 404 communicates with a system memory 406, one or more storage devices 408, one or more input/output interfaces 410, one or more communications interfaces 412, or a combination thereof. The system memory 406 includes non-transitory computer readable media, including volatile memory devices (e.g., random access memory (RAM) devices), nonvolatile memory devices (e.g., read-only memory (ROM) devices, programmable read-only memory, and flash memory), or both. The system memory 406 includes an operating system 414, which may include a basic input/output system for booting the computing device 402 as well as a full operating system to enable the computing device 402 to interact with users, other programs, and other devices. The system memory 406 includes one or more applications 416 (e.g., instructions) which are executable by the processor 404. For example, when the computing device 402 is the computer system 102 of FIG. 1, the one or more applications 416 include the data acquisition system 112, the inference engine 114, the training skill model 116, the flight operation skill model 118, the AS probability model 120, and the decision engine 122.

In some configurations, the processor 404 communicates with the one or more storage devices 408. For example, the storage device 408 includes non-transitory computer readable media that can include nonvolatile storage devices, such as magnetic disks, optical disks, or flash memory devices. The storage devices 408 can include both removable and non-removable memory devices. The storage devices 408 can be configured to store an operating system, images of operating systems, applications, and program data. In particular implementations, the system memory 406, the storage device 408, or both, include tangible computer-readable media incorporated in hardware and which are not signals.

In some configurations, the processor 404 communicates with the one or more input/output interfaces 410 that enable the computing device 402 to communicate with one or more input/output devices 418 to facilitate user interaction. The input/output interfaces 410 can include serial interfaces (e.g., universal serial bus (USB) interfaces or Institute of Electrical and Electronics Engineers (IEEE) interfaces), parallel interfaces, display adapters, audio adapters, and other interfaces (“IEEE” is a registered trademark of The Institute of Electrical and Electronics Engineers, Inc. of Piscataway, New Jersey). The input/output devices 418 can include keyboards, pointing devices, displays (e.g., one or more monitors, one or more gauges, etc.), speakers, microphones, touch screens, rotatable selectors, levers, knobs, slides, switches, and other devices. The processor 404 detects interaction events based on user input received via the input/output interfaces 410. Additionally, the processor 404 sends a display to a display device via the input/output interfaces 410.

In some configurations, the processor 404 can communicate with one or more devices 420 via the one or more communications interfaces 412, such as the system interfaces 106 of FIG. 1. The one or more devices 420 can include external computing devices contacted via a communication network and controllers, sensors, and other devices coupled to the computing device 402 via wired or wireless local connections. For example, when the computing device 402 is the computer system 102 of FIG. 1, the computing device 402 is configured to communicate via the interface 412 with devices external to the computer system 102 such as the user device 126 and the data sources 144. The one or more communications interfaces 412 may include wired Ethernet interfaces, IEEE 802 wireless interfaces, other wireless communication interfaces, one or more converters to convert analog signals to digital signals, electrical signals to optical signals, one or more converters to convert received optical signals to electrical signals, or other network interfaces.

In some implementations, a non-transitory, computer readable medium stores instructions that, when executed by one or more processors, cause the one or more processors to initiate, perform, or control operations to perform part or all of the functionality described above. For example, the instructions may be executable to implement one or more of the operations or methods described with respect to FIG. 1 and FIG. 2. In some implementations, part or all of one or more of the operations or methods associated with FIG. 1 and FIG. 2 may be implemented by one or more processors (e.g., one or more central processing units (CPUs), one or more graphics processing units (GPUs), one or more digital signal processors (DSPs)) executing instructions, by dedicated hardware circuitry, or any combination thereof.

The computing device 402 of FIG. 4 may be connected to, or be part of, a network. For example, the network may include multiple nodes. Each node may correspond to a computing device, such as the computing device 402, or a group of nodes combined may correspond to the computing device 402. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing device 402 may be located at a remote location and connected to the other elements over a network.

In some implementations, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes in the network may be configured to provide services for one or more user devices (e.g., user device 126 of FIG. 1). For example, the nodes may be part of a cloud computing system. The nodes may include functionality to receive requests from the user device 126 and transmit responses to the user device 126.

The computing device 402 or a group of computing device s include functionality to perform a variety of operations disclosed herein. For example, the computing device(s) 402 may perform communication between processes on the same system or different systems. A variety of mechanisms, employing some form of active or passive communication, may facilitate the exchange of data between processes on the same device. Examples representative of these inter-process communications include the implementation of a file, a signal, a socket, a message queue, a pipeline, a semaphore, shared memory, message passing, and a memory-mapped file.

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

The computing device 402 may implement and/or be connected to a data repository. For example, one type of data repository is a database, which is also referred to herein as a base. A database is a collection of information configured for ease of data retrieval, modification, re-organization, and deletion. Database Management System (DBMS) is a software application that provides an interface for users to define, create, query, update, or administer databases.

The computing device 402 may include functionality to present raw and/or processed data, such as results of comparisons and other processing. For example, presenting data may be accomplished through various presenting methods. Specifically, data may be presented through a user interface provided by a computing device.

The illustrations of the examples described herein are intended to provide a general understanding of the structure of the various implementations. The illustrations are not intended to serve as a complete description of all of the elements and features of apparatus and systems that utilize the structures or methods described herein. Many other implementations can be apparent to those of skill in the art upon reviewing the disclosure. Other implementations can be utilized and derived from the disclosure, such that structural and logical substitutions and changes can be made without departing from the scope of the disclosure. For example, method operations can be performed in a different order than shown in the figures or one or more method operations can be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results can be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features can be grouped together or described in a single implementation for the purpose of streamlining the disclosure. Examples described above illustrate but do not limit the disclosure. It should also be understood that numerous modifications and variations are possible in accordance with the principles of the subject disclosure. As the following claims reflect, the claimed subject matter can be directed to less than all of the features of any of the disclosed examples. Accordingly, the scope of the disclosure is defined by the following claims and their equivalents.

Further, the disclosure comprises embodiments according to the following examples:

According to Example 1, a method includes receiving, at one or more computing systems of a training development system, a request to determine a training program for a member of an entity from a requestor; determining, at the one or more computing systems, training skill scores for the member for monitored conditions based on a training history associated with the member; determining, at the one or more computing systems, operation skill scores for the member for the monitored conditions based on operation history associated with the member; determining, at the one or more computing systems, a first anomalous state probability profile for the member based on the training skill scores and the operation skill scores; determining, at the one or more computing systems, additional anomalous state probability profiles for the member based on the member having additional training from sets of one or more training courses; and generating, at the one or more computing systems, a training program for the member based on the first anomalous state probability profile and the additional anomalous state probability profiles, wherein the training program specifies one or more training courses for the member.

Example 2 includes the method of Example 1, wherein the entity comprises one or more aircraft pilots.

Example 3 includes the method of Example 2, wherein said generating the training program includes generating a training program for each aircraft pilot of the one or more aircraft pilots.

Example 4 includes the method of Example 1 or Example 2, wherein the training history is retrieved from a training knowledge base.

Example 5 includes the method of any of Examples 1 to 4, wherein the operation history is retrieved from an operations knowledge base.

Example 6 includes the method of any of Examples 1 to 5 and further includes searching a plurality of data sources for new data relevant to the training development system; and updating a data lake with the new data, wherein the data lake comprises data structures for data relevant to the training development system including a training knowledge base and an operations knowledge base.

Example 7 includes the method of any of Examples 1 to 6, wherein said determining the training skill scores further comprises utilizing a deviation measurement framework to determine a degree of deviation of training performance from expected performance.

Example 8 includes the method of any of Examples 1 to 7, wherein said determining the operation skill scores further comprises utilizing a deviation measurement framework to determine a degree of deviation of expected performance from actual performance.

Example 9 includes the method of any of Examples 1 to 8 and further includes generating, at the one or more computing systems, training course information pertaining to suggested updates for training courses, new training courses, or both; and providing the training course information to training course providers, personnel with authority to approve updates to training programs and new training programs, or combinations thereof.

Example 10 includes the method of any of Examples 1 to 9 and further includes providing output to the requestor, wherein the output includes a training program for each member of the entity, at least a portion of a training history for each member of the entity, at least a portion of operation performance over time, or a combination thereof.

According to Example 11, a device includes a memory configured to store instructions; and one or more processors configured to execute the instructions to perform the method of any of Examples 1 to 10.

According to Example 12, a non-transitory, computer-readable medium stores instructions that, when executed by one or more processors cause the one or more processors to perform the method of any of Examples 1 to 10.

According to Example 13, an apparatus includes means for carrying out the method of any of Examples 1 to 10.

According to Example 14, a non-transitory, computer-readable medium comprising instructions that, when executed by one or more processors, cause the one or more processors to: receive a request to determine a training program for a member of an entity from a requestor; determine training skill scores for the member for monitored conditions based on a training history associated with the member; determine operation skill scores for the member for the monitored conditions based on operation history associated with the member and the training skill scores; determine a first anomalous state probability profile for the member based on the training skill scores; determine additional anomalous state probability profiles for the member based on the member having additional training from sets of one or more training courses; and generate a training program for the member based on the first anomalous state probability profile and the additional anomalous state probability profiles, wherein the training program specifies one or more training courses for the member.

Example 15 includes the non-transitory, computer-readable medium of Example 14, wherein particular instructions of the instructions that determine the training skill scores further comprise first instructions to use a deviation measurement framework to determine a degree of deviation of training performance from expected performance.

Example 16 includes the non-transitory, computer-readable medium of Example 14 or Example 15, wherein particular instructions of the instructions that determine the operation skill scores further comprise second instructions to use a deviation measurement framework to determine a degree of deviation of expected performance from actual performance.

Example 17 includes the non-transitory, computer-readable medium of any of Examples 14 to 16, wherein the instructions further comprise instructions to cause the one or more processors to: search a plurality of data sources for new data relevant to a training development system; and update a data lake with the new data, wherein the data lake comprises data structures for data relevant to the training development system including a training knowledge base and an operations knowledge base, wherein the training skill scores are based on first particular data from the training knowledge base, and wherein the operation skill scores are based on second particular data from the operations knowledge base.

Example 18 includes the non-transitory, computer-readable medium of any of Examples 14 to 17, wherein the instructions further comprise instructions to cause the one or more processors to provide output to the requestor, wherein the output includes a training program for each member of the entity, at least a portion of a training history and training performance for each member of the entity, and at least a portion of operation performance over time.

According to Example 19, a system includes a data lake including data associated with training and operation of particular equipment; and one or more processors configured to execute instructions to: use a training skill model to determine training skill scores for a member of an entity associated with use of the particular equipment; use an operation skill model to determine operation skill scores for use of the particular equipment by the member; use an anomalous state probability model to determine anomalous state profiles associated with the particular equipment for the member; and use a decision engine to determine a training program for the member based on the anomalous state profiles.

Example 20 includes the system of Example 19, wherein the particular equipment comprises an aircraft.

Example 21 includes the system of Example 19 or Example 20, wherein an anomalous state profile of the anomalous state profiles comprises likelihoods of particular monitored conditions during use of the particular equipment, consequences of occurrence of the particular monitored conditions, and severity of the particular monitored conditions.

Example 22 includes the system of any of Examples 19 to 21, wherein the decision engine is further configured to determine updates for training courses, content for new training courses, or both.

Example 23 includes the system of any of Examples 19 to 22, wherein the instructions are further executable by the one or more processors to use a data acquisition system to find new data relevant to a training program development system and to update data structures in the data lake with the new data.

What is claimed is:

1. A method comprising:
receiving, at one or more computing systems of a training development system, a request to determine a training program for a member of an entity from a requestor;
determining, at the one or more computing systems, training skill scores for the member for monitored conditions based on a training history associated with the member;
determining, at the one or more computing systems, operation skill scores for the member for the monitored conditions based on operation history associated with the member;
determining, at the one or more computing systems, a first anomalous state probability profile for the member based on the training skill scores and the operation skill scores;
determining, at the one or more computing systems, additional anomalous state probability profiles for the member based on the member having additional training from sets of one or more training courses; and
generating, at the one or more computing systems, a training program for the member based on the first anomalous state probability profile and the additional anomalous state probability profiles, wherein the training program specifies one or more training courses for the member.

2. The method of claim 1, wherein the entity comprises one or more aircraft pilots.

3. The method of claim 2, wherein said generating the training program includes generating a training program for each aircraft pilot of the one or more aircraft pilots.

4. The method of claim 1, wherein the training history is retrieved from a training knowledge base.

5. The method of claim 1, wherein the operation history is retrieved from an operations knowledge base.

6. The method of claim 1, further comprising:
searching a plurality of data sources for new data relevant to the training development system; and
updating a data lake with the new data, wherein the data lake comprises data structures for data relevant to the training development system including a training knowledge base and an operations knowledge base.

7. The method of claim 1, wherein said determining the training skill scores further comprises utilizing a deviation measurement framework to determine a degree of deviation of training performance from expected performance.

8. The method of claim 1, wherein said determining the operation skill scores further comprises utilizing a deviation measurement framework to determine a degree of deviation of expected performance from actual performance.

9. The method of claim 1, further comprising:
generating, at the one or more computing systems, training course information pertaining to suggested updates for training courses, new training courses, or both; and
providing the training course information to training course providers, personnel with authority to approve updates to training programs and new training programs, or combinations thereof.

10. The method of claim 1, further comprising providing output to the requestor, wherein the output includes a training program for each member of the entity, at least a portion of a training history for each member of the entity, at least a portion of operation performance over time, or a combination thereof.

11. A non-transitory, computer-readable medium comprising instructions that, when executed by one or more processors, cause the one or more processors to:
receive a request to determine a training program for a member of an entity from a requestor;
determine training skill scores for the member for monitored conditions based on a training history associated with the member;
determine operation skill scores for the member for the monitored conditions based on operation history associated with the member and the training skill scores;
determine a first anomalous state probability profile for the member based on the training skill scores;
determine additional anomalous state probability profiles for the member based on the member having additional training from sets of one or more training courses; and
generate a training program for the member based on the first anomalous state probability profile and the additional anomalous state probability profiles, wherein the training program specifies one or more training courses for the member.

12. The non-transitory, computer-readable medium of claim 11, wherein particular instructions of the instructions that determine the training skill scores further comprise first instructions to use a deviation measurement framework to determine a degree of deviation of training performance from expected performance.

13. The non-transitory, computer-readable medium of claim 11, wherein particular instructions of the instructions that determine the operation skill scores further comprise second instructions to use a deviation measurement framework to determine a degree of deviation of expected performance from actual performance.

14. The non-transitory, computer-readable medium of claim 11, wherein the instructions further comprise instructions to cause the one or more processors to:
search a plurality of data sources for new data relevant to a training development system; and
update a data lake with the new data, wherein the data lake comprises data structures for data relevant to the training development system including a training knowledge base and an operations knowledge base, wherein the training skill scores are based on first particular data from the training knowledge base, and wherein the operation skill scores are based on second particular data from the operations knowledge base.

15. The non-transitory, computer-readable medium of claim 11, wherein the instructions further comprise instructions to cause the one or more processors to provide output to the requestor, wherein the output includes a training program for each member of the entity, at least a portion of a training history and training performance for each member of the entity, and at least a portion of operation performance over time.

16. A system comprising:
a data lake including data associated with training and operation of particular equipment; and
one or more processors configured to execute instructions to:
use a training skill model to determine training skill scores for a member of an entity associated with use of the particular equipment;
use an operation skill model to determine operation skill scores for use of the particular equipment by the member;
use an anomalous state probability model to determine anomalous state profiles associated with the particular equipment for the member; and
use a decision engine to determine a training program for the member based on the anomalous state profiles.

17. The system of claim 16, wherein the particular equipment comprises an aircraft.

18. The system of claim 16, wherein an anomalous state profile of the anomalous state profiles comprises likelihoods of particular monitored conditions during use of the particular equipment, consequences of occurrence of the particular monitored conditions, and severity of the particular monitored conditions.

19. The system of claim 16, wherein the decision engine is further configured to determine updates for training courses, content for new training courses, or both.

20. The system of claim 16, wherein the instructions are further executable by the one or more processors to use a data acquisition system to find new data relevant to a training program development system and to update data structures in the data lake with the new data.
